(19) United States
(12) Patent Application Publication
(10) Pub. No.: US 2012/0102520 A1
(43) Pub. Date: Apr. 26, 2012

(54) VIDEO CO-ORDINATING TIME-BASED DATA SYSTEM

(76) Inventor: Thomas A. Motzel, Eagan, MN (US)

(21) Appl. No.: 12/909,498

(22) Filed: Oct. 21, 2010

(51) Int. Cl. H04N 7/16; H04N 7/173

(52) U.S. Cl. 725/30; 725/97

(57) ABSTRACT

By means of the present invention, coordination and synchronization of independently obtained and stored video recordings which may be relatively lengthy with short term, isolated happenings or collections of segment of video depicting acts or facts may be easily extracted for viewing.

### CROSS-REFERENCED TO RELATED APPLICATIONS

Not applicable

### STATEMENT REGARDING FEDERALLY SPONSORED RESEARCH OR DEVELOPMENT

Not applicable

### BACKGROUND OF THE INVENTION

I. Field of the Invention

The present invention relates generally to the field of accessing and viewing media recordings of events uploaded to a website and, more particularly, to a method for correlating and viewing segments of a recorded event based on time-based or time-stamped facts uploaded by others at the associated event.

II. Related Art

Many events, particularly amateur sporting events, are routinely recorded in video form and the recordings are shared in the form of VHS or DVD copies or shared via internet-based video distribution tools such as You Tube. These methods of distributing are convenient for simply sharing the original recorded material with people in interested groups, however, they lack the efficiency required for a quick review of critical segments or, in the case of team sports, for example, the ability to review the event by isolating parts that particularly apply to participating individuals and specific incidents to provide an analysis of the performance of that individual for mentoring or coaching purposes.

While professional sports teams, for example, can afford sophisticated video equipment to record many aspects of games and individual performances, the great majority of competition involves amateur low-budget teams, particularly teams in youth sports, that have little resources to provide detailed information regarding key events or to follow individual performances during a game.

In youth sports, for example, team parents or friends are often the ones to video tape games or practices. After each game or other taped event, the parent or friend downloads the video (typically 30-90 minutes of footage) to a personal computer (PC) and then utilizes a software application to transfer footage to a removable media such as a DVD. The entire process may take 2-4 days by the time the recording is finished and a final product is delivered to the coach or other leader.

Once a coach or other leader has the video, it generally takes another 1-3 hours for an actual review. This process can be painstakingly slow as it is necessary to fast forward and rewind the video may times in an effort to find and review significant moments from the event.

Upon completion of such review, it is often desirable to share ‘learning moments’ with the athletes. There are two readily available ways of doing this: 1) edit, copy and record another DVD to share with a youth athlete, OR 2) use practice time to review video with the whole team. Unfortunately, neither of these approaches is convenient given the time and resources generally available at the youth level. Therefore, using video as a teaching tool remains difficult and unrealistic when the conventional methods are used.

More recently, handheld mobile electronic devices have come into wide use. Recent advancements have brought about a revolution in mobile applications. Cell phones are quickly being replaced by “smart phones” and it is reasonable to assume that in the near future, most people will be carrying smart phones of some type and utilizing innovative applications for many tasks.

This means that many interested people attending a typical youth sporting event or other group activity will be carrying such devices and at least some of them will be recording segmented data during any given event using a smart phone, or the like. Examples include tracking game statistics instead of writing them in ‘the book’, or the like, (often seen in the hands of an assistant coach). These stats are valuable as a way to identify the strengths and weaknesses of a team and/or individual members.

But how much more valuable would the process be if you could correlate each statistic or segmented moment with instantaneous review of the corresponding video footage extracted from a complete recording? That would solve a definite present need.

### SUMMARY OF THE INVENTION

By means of the present invention, coordination and synchronization of independently produced and stored or reviewable video material, which may be relatively lengthy, with short term, isolated happenings or collections of short segments of video depicting acts or facts may be easily extracted for independent viewing.

In one embodiment, the method makes use of a common internet website which can accommodate a number of accounts for sports teams, classes or other groups, possibly subscribing members of the public at large, which may be interested in excerpts from shared video. A plurality of private accounts can be created whereby the stored content of uploaded video or other recorded media can be accessed by members of a group as large as the public or other selected group of stakeholders with an interest.

The invention enables a viewer to select and coordinate time-stamped, short segments of video of interest to that particular viewer extracted from a full length video. For instance, shots taken by a particular player in a recorded basketball game, or the like, which may be of interest to a parent or coach can be time-stamped or “marked up” by a person other than the one recording the event using a portable “smart phone” or other such time-coordinated device may later be easily retrieved from the full recording.

The method may be accomplished using the following sequence. A recorded real-time video or other video of interest or other media type of recording obtained from a first source (i.e., someone filming an event or producing a video stream for broadcasting or other viewing) is uploaded using a PC or the like and from there online to produce an accessible event recording stored in a particular selected account online. One or more sets of time-stamped facts, moments of interest, etc., received from one or more second sources at the recorded event or viewing the video are also enabled to be uploaded to the account, these being related to happenings in the recorded material. Certain selected viewers of a class or population of persons of interest are granted to access the account online as with a user name and password and, thereafter, select an uploaded video recording and, optionally, select an uploaded set of time-stamped facts associated with the recording. The selected viewer given access is enabled to further select a frame of the recording that synchronizes with a time-stamped fact of interest in the selected set of time-stamped facts, thereby correlating the event recording with the entire set of selected time-stamped facts and enabling the viewer to navigate the recording according to the corresponding time-stamped facts.

Each event recording is related to a particular one of a plurality of accounts at an online site and the up-loading preferably requires logging into the account.

In this manner, multiple stakeholders with some common and some diverse interests can be granted access to the stored content of a recording.

Revenue can be derived from the accounts and from those entities having online accounts and those viewers granted private access to the stored content and the right to upload time-stamped facts or the like.

In addition to the above embodiments, the on-line tool of the invention could be used by a network or studio, for example, that desired to make video content of any program available for similar mark-up and review. For example, a teacher may want to utilize and synchronize footage from an educational or documentary program and later use segments as teaching tools. Networks, cable companies, satellite or other TV transmitting companies and video production houses could sell memberships to subscribers for a nominal fee, which would make content available to subscribers from the general public. Businesses that make on-line web-based video available to the public free could support the business by selling on-line advertising. Mark-ups can include audio references or other explanatory matter.

### BRIEF DESCRIPTION OF THE DRAWINGS

In the drawings wherein like numerals designate like parts throughout the same:

FIG. 1 is a block diagram illustrating a preferred embodiment of the method of the invention.

### DETAILED DESCRIPTION

The following detailed description is directed to illustrate the details of one or more embodiments capturing the concepts of the present invention. Any described embodiments are meant as examples and are not meant to limit the scope of the invention in any manner, as variations within the scope of the invention concepts may occur to those skilled in the art.

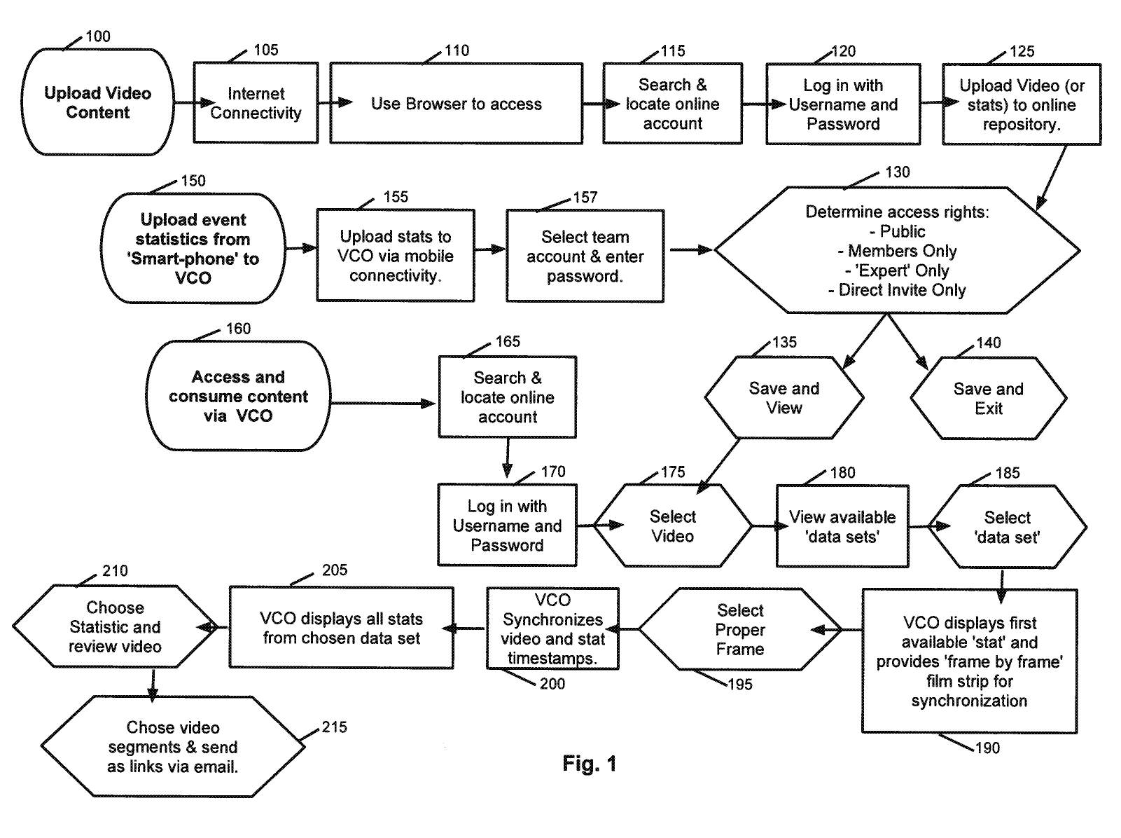

In FIG. 1 there is shown a block diagram that illustrates the principles of the method of the present invention which should provide an overall understanding of how it is intended to work. Block 100 illustrates a recording of an event which is generally in video form and is uploaded using an Internet connection such as, but not limited to, using a computer such as a home personal computer at 105. Once the event recording is connected into the personal computer, the personal computer user thereafter accesses the website associated with an account of the particular team, group or other entity for which the video was made or is of interest. This is shown at 110. Once the website is accessed, the user can then search and locate the team or other account of interest at 115. Typically, the user will then be required to log in to that account using a user name and password, as shown at 120. The password will be associated with a particular team or other population for which a number of users have been granted access. Once the user is properly logged into the system, the video can then be uploaded to the particular online repository associated with that group or team, as shown at 125. The repository is a limited access repository and is illustrated at 130. Save and view and save and exit options are shown at 135 and 140.

Interested persons, normally interested viewers of the event or of the video, contemporaneously with the making or viewing of the video can use mobile devices or other markers and time-stamp statistics, acts or facts, moments of interest, etc. occurring during the recorded event or other video material. These persons can also access recorded material or footage to input time-stamped data, possibly from a mobile device such as a “smart phone”, as shown at 150 and connected at 155 via a mobile connectivity. As with the depositing of original recordings, the interested observer will normally be required to enter a password in order to access a particular selected account once the website is accessed. This is shown at 157. This, of course, will be the same account that holds the original uploaded event video or other recording. In this regard, the owners of the unique data sets can determine access rights along with the group or team owning the account, as shown in block 130. Thus, access may be made as open to anyone in the general public subscribing to the owner or as limited as the account owner or team desires.

Block 160 describes a viewing or access entry point. In this manner, anyone can have access to the website from any internet browser, as well as the ability to search and locate particular accounts, such as a particular team account shown at 165. Once the team or other account of interest is located at 165, in order to gain access to actual system content, the viewer will have to provide any necessary access information, generally in the form of a user name and team password.

From this point, the viewer can be presented with a list of video titles for which member access has been granted to select the event or material of interest as at 175. Once a specific recording is chosen, a list of “data sets” that have been uploaded via handheld or other devices for the chosen event recording will appear as in block 180. The viewer may then select a data set at 185. The online system will then display the list of recorded data from the selected upload sequence with user defined labels in chronological order as at 190. At the same time, the viewer will be presented with a “film strip” and the ability to navigate frame by frame. The viewer can then chose the frame that matches the first recorded stat, or the like, as shown in block 195, and the online system will synchronize the time stamps of the video and time stamps as at 200 and the video will advance to that selected sequence. From this point, the viewer can navigate the video by simply clicking on particular items from the data set at 210.

In addition, for example, if someone reviewing a tape wants to share a specific play with another interested subscriber, member of the team, etc., they will also have the ability to define an increment of time before and after the “time stamp” and send a link via email highlighting a particular segment at 215.

This invention has been described herein in considerable detail in order to comply with the patent statutes and to provide those skilled in the art with the information needed to apply the novel principles and to construct and use embodiments of the example as required. However, it is to be understood that the invention can be carried out by specifically different devices and that various modifications can be accomplished without departing from the scope of the invention itself.

What is claimed is:

1. A method of using uploaded event recordings synchronized with independently uploaded selected time-stamped facts of interest comprising:
(a) enabling uploading of a recorded video or other type of recording obtained from a first source using internet connectivity to produce an accessible event recording stored in a particular selected account online;
(b) enabling uploading of one or more sets of time-stamped indicators received from one or more second sources associated with said recorded event to said account, said facts being related to said event and segments of said recording;
(c) enabling a certain selected population of users meeting access criteria to access said account on-line as with a user name and password and select an uploaded event recording and optionally select an uploaded set of one or more time-stamped facts of interest associated with said event recording;
(d) enabling said selected user to further identify a frame of said event recording that synchronizes with a time-stamped fact of interest in said set of time-stamped facts of interest thereby correlating said event recording with said set of time-stamped facts; and
(e) enabling said viewer to navigate said recording according to said corresponding set of time-stamped facts of interest and assimilate segments of video based thereon.

2. A method as in claim 1 wherein each said event recording is related to a particular one of a plurality of accounts at an online site.

3. A method as in claim 2 wherein said uploading requires logging into said account.

4. A method as in claim 1 including limiting access rights of said selected viewers to viewing said event recording.

5. A method as in claim 1 wherein said event recording is a video recording.

6. A method as in claim 4 wherein said selected viewers are required to have a user name and password to access said event recording.

7. A method as in claim 1 wherein said set of time-stamped facts are uploaded from a mobile device.

8. A method of assimilating selected segments from a source of video material based on time-stamped selected identifiers or intervals, comprising:
(a) enabling access of a population of subscribers to video material made available by owners of rights to the video for assimilating selected segments thereof;
(b) enabling said subscribers to further identify a frame of said video material that synchronizes with a time-stamped fact or interval of interest in a set of time-stamped facts or intervals of interest identified by said subscriber, thereby correlating said video with said set of time-stamped facts;
(c) enabling said subscribers to navigate said video material according to corresponding time-stamped facts in said set of time-stamped facts of interest and assimilating video segments based thereon.

9. A method as in claim 8 wherein said access is obtained by payment of a subscription or membership to said owner of rights.

10. A method as in claim 8 wherein said access is free and supported by on-line advertising.
